(19) United States
(12) Patent Application Publication
(10) Pub. No.: US 2016/0025481 A1
(43) Pub. Date: Jan. 28, 2016

(54) IN VITRO DETERMINATION OF SUNSCREEN PROTECTION BASED ON IMAGE ANALYSIS OF SUNSCREENS APPLIED TO SKIN

(71) Applicants: Joseph W. STANFIELD, (US); Joseph William STANFIELD, III, (US); SUNCARE RESEARCH LABORATORIES, LLC, Winston-Salem., NC (US)

(72) Inventors: Joseph William Stanfield, Winston-Salem, NC (US); Joseph William Stanfield, III, Winston-Salem, NC (US)

(73) Assignee: SUNCARE RESEARCH LABORATORIES, LLC, Winston-Salem, NC (US)

(21) Appl. No.: 14/775,944

(22) PCT Filed: Mar. 14, 2014
(86) PCT No.: PCT/US2014/026945

§ 371 Date: Sep. 14, 2015

Related U.S. Application Data
(60) Provisional application No. 61/789,893, filed on Mar. 15, 2013.

(51) Int. Cl. G01B 11/06

(52) U.S. Cl. CPC G01B 11/0625; G01B 11/0658

(57) ABSTRACT

Described herein are processes, apparati, and substrates for acquiring images of sunscreen films on human skin for in vitro determination of sunscreen protection factors (SPF) incorporating image analyses.

### CROSS REFERENCE TO RELATED APPLICATIONS

This application is a U.S. national phase application under 35 U.S.C. §371 of International Patent Application No. PCT/US2014/026945, filed Mar. 14, 2014, that claims priority to U.S. Provisional Patent Application No. 61/789,893, filed Mar. 15, 2013, each of which is incorporated by reference herein in its entirety.

### TECHNICAL FIELD

Described herein are processes, apparati, and substrates for acquiring images of sunscreen films on human skin for in vitro determination of sunscreen protection factors (SPF) incorporating image analyses.

### BACKGROUND

### SPF Measurements on Human Subjects

Sunscreens protect against sunburn and diminish the risk of skin cancer and premature aging by absorbing energy from sunlight before it reaches the skin. The primary in vivo measure of protection by a sunscreen is the sun protection factor (SPF). Typically, the SPF is measured in a laboratory on human volunteers by applying 2 mg/cm² of sunscreen to an area of the mid-back, allowing the sunscreen to dry for 15 minutes, and then administering a series of five doses of ultraviolet radiation (UVR), simulating sunlight, to skin sites treated with the sunscreen. Another series of five UVR doses is applied within a skin area without the sunscreen. After 24 hours, the irradiated skin sites are examined to determine the SPF. The SPF is the lowest dose of UVR that caused mild sunburn in the sunscreen-treated area, divided by the lowest dose of UVR that caused mild sunburn in the area without sunscreen, defined as the minimal erythema dose (MED). Thus, for a sunscreen with an SPF of 25, an applied UV dose of 25 MEDs would be required for the skin to absorb one MED. The label SPF of a sunscreen product is based on the average SPF for 10 human volunteers. Label SPF values range from 2 to more than 100. See U.S. Food and Drug Administration, 21 CFR Parts 201 and 310, Federal Register, Vol. 76, No. 117, Friday, Jun. 17, 2011, pp. 35620-35665.

Because the current SPF measurement procedure requires administration of sunburning doses of UVR to humans, and UVR causes discomfort and premature aging of skin, and is a known carcinogen, it is desirable to replace the current in vivo method of measuring SPF with a reliable vitro method.

### In Vitro Measurements of Sunscreen Protection

The basic in vitro measure of UV protection is the transmission spectrum, which is used to compute absolute indices of protection, such as SPF and UVA protection factor (UVAPF). The logarithmic transformation of the transmission spectrum yields the absorbance spectra that are currently used for determination of ratios, such as UVA/UVB, the critical wavelength and the spectral uniformity index. See Boots UK Limited, Measurement of UVA:UVB ratio according to the Boots Star rating system (2011); In vitro UV Protection Method Task Force, In vitro method for the determination of the UVA protection factor and critical wavelength values of sunscreen products, COLIPA, 2011; U.S. Food and Drug Administration, 21 CFR Parts 201 and 310, Federal Register, Vol. 76, No. 117, Friday, Jun. 17, 2011, pp. 35620-35665; Diffey, Int. J. Cosmet. Sci. 16:47-52 (1994); and Diffey, Int. J. Cosmet. Sci., 31:63-68 (2009).

The SPF measured on human subjects typically serves as a benchmark for validating in vitro measurement results. A major problem in validating in vitro measurements of SPF is selecting the appropriate in vitro SPF value to compare to the in vivo SPF. For example, a photolabile sunscreen labeled as SPF 25 has an SPF that is substantially higher than 25, initially, and substantially lower than 25 after receiving a UV dose of 25 MEDs.

Changes in absorbance spectra, during or after a series of applied UV doses permit quantitative assessment of photostability of the sunscreen active ingredients. Tronnier et al. reported a method for continuously irradiating a sunscreen and measuring total applied and transmitted erythemal effective UV dose using detectors with an erythemally-weighted response, over the UV wavelength range of 290-400 nm. The SPF was computed as the applied effective UV dose when the transmitted erythemal effective UV dose reached 1 MED. See Tronnier et al., Perfumerie and Kosmetik 77:326-329 (1996); Kockott et al., Automatic in vitro evaluation of sun care products. In: Proceedings of the 21st IFSCC Congress, Berlin (2000).

The method of Tronnier et al. has been extended by measuring the transmitted spectral irradiance at each wavelength over the UV wavelength range of 290-400 nm at discrete time points, using a spectroradiometer, and integrating the spectral irradiance values to compute the transmitted erythemal effective UV dose. In this approach, a continuous least-squares power curve fit equation is utilized to permit computation of SPF and provide an index of photostability. See Stanfield, Cosmet. Sci. 52:412-413 (2001); Stanfield, In vitro techniques in sunscreen development. In: Shaath, Sunscreens: Regulations and Commercial Development (2005); and Stanfield, SÖFW J. 132:19-22 (2006). The resulting UV Dose Response Model also provides the unique absorbance spectrum corresponding to the SPF (i.e., the Integrated Absorbance). The Integrated Absorbance Spectrum is appropriate for use in computing the ratios UVA/UVB and UVAPF/SPF, the critical wavelength and the spectral uniformity index that are consistent with absolute measures of protection. See Boots UK Limited, Measurement of UVA:UVB ratio according to the Boots Star rating system (2008); FDA, Sunscreen Drug Products for Over-the-Counter Human Use: Proposed Amendment of Final Monograph Proposed Rule, Federal Register, Vol. 72 165, 49070-49122 (2007); Diffey, Int. J. Cosmet. Sci. 16:47-52 (1994); Diffey, Int. J. Cosmet. Sci. 31:63-68 (2009).

The Integrated Absorbance Spectrum is determined using a procedure analogous to that of the Dose Response SPF model: The ratio of the unweighted transmitted and applied UV doses is determined for each wavelength at the point in time, tMED, when the sunscreen has transmitted one MED. The resulting ratio at each wavelength is used to compute a transmission spectrum that yields the Integrated Absorbance Spectrum. See Stanfield, Osterwalder, & Herzog, Photochem. Photobiol. Sci. 9 489-494 (2010) which is incorporated herein by reference in its entirety for teaching methods to calculate the Integrated Absorbance Spectrum and SPF.

Development of reliable in vitro methods for measuring sunscreen protection presents significant challenges:
In vitro measurements of sunscreen protection require repeatable applications of the appropriate amount of sunscreen to substrates that provide the film thickness distribution observed on human skin and permit accurate measurements of the transmitted UVR.
Measurements must account for lack of photostability, using measurements of transmission or absorbance spectra before irradiation and after several UV doses, chosen for consistency with the in vivo SPF. See, e.g., Stanfield, Osterwalder, & Herzog, Photochem. Photobiol. Sci. 9: 489-494 (2010).
Spectroradiometric instrumentation must have sufficient dynamic range, signal-to-noise ratio, spatial response, speed of measurement, wavelength accuracy, and rejection of out-of-band radiation.
UV doses required for absorbance measurements should not be high enough to change the properties of the sample significantly.
The sample irradiation lamp should comply with the spectral and total irradiance requirements of the COLIPA in vitro UVA protection Method and ISO Standard 24443, in order to match the behavior of the sunscreen during in vivo SPF determination. See COLIPA (now Cosmetics Europe), In vitro UV Protection Method Task Force, In vitro method for the determination of the UVA protection factor and critical wavelength values of sunscreen products (2009); ISO International Standard, ISO/24443, Cosmetics—Sun Protection test method—Determination of Sunscreen UVA Photoprotection in vitro.
The substrate temperature range should be controlled to remain within the range of actual skin temperatures during UV irradiation.

Presently, in vitro measurements do not provide reliable determinations of sunscreen protection. In fact, even the in vivo SPF measured on human subjects does not accurately describe the degree of sun protection outdoors. Due to limitations on the duration of testing, the intensity of the lamps used for human SPF testing is approximately 30 times the intensity of noon sunlight. Therefore, the infrared and visible wavelengths are filtered out from the concentrated power of the testing lamps to avoid reaching the pain threshold during UVR exposures. Laboratory solar simulators do not simulate the solar spectra most frequently encountered by the world population, and tend to overestimate the actual SPF protection realized in sunlight. See Seite et al., Photodermatol. Photoimmunol. Photomed. 22: 67-77 (2006).

Once in vitro methods are validated against benchmark in vivo SPF values, it will be possible to determine sunscreen absorbance spectra using lamps that provide more accurate simulation of sunlight. The Integrated Absorbance Spectrum measured with such a lamp may then be used for determination of SPF, as well as ratios, such as UVA/UVB, UVAPF/SPF, the critical wavelength, and spectral uniformity index that more accurately represent actual protection in sunlight. See Boots UK Limited, Measurement of UVA:UVB ratio according to the Boots Star rating system (2008); FDA, Sunscreen Drug Products for Over-the-Counter Human Use: Proposed Amendment of Final Monograph Proposed Rule, Federal Register, Vol. 72 165, 49070-49122 (2007); Diffey, Int. J. Cosmet. Sci. 16: 47-52 (1994); and Diffey, Int. J. Cosmet. Sci. 31: 63-68 (2009).

### Substrates for In Vitro Measurements of Sunscreen Protection

Several substrates have been utilized in efforts to obtain reliable, accurate in vitro SPF measurement spectra over the past 20 years, including Vitroskin®, a surgical tape labeled as Transpore™ (3M), and Mimskin® v.1.0.

In the development of Vitroskin®, Sottery provided a substrate composition and surface similar to those of skin, by incorporating protein, lipids, and salts, and simulating the hydration, pH, surface tension, and ionic strength of skin in order to model the surface interaction of sunscreens and skin. See FDC Reports, Inc., FDC Reports: “The Rose Sheet®”, Toiletries, Fragrances and Skin Care 14: 44, 15 (1993). Vitroskin®, however does not replicate the thickness distribution of sunscreens on skin.

Transpore™ lacks a topography that simulates skin, and is not compatible with many of the ingredients currently used in sunscreen products. Mimskin® v.1.0 (The Australian Photobiology Testing Facility) is claimed to permit evaluation of UVA protection only.

In current practice, the most commonly used substrates for in vitro measurements of sunscreens are polymethylmethacrylate (PMMA) plates that do not closely resemble skin, but are well characterized and commercially available with controlled roughness values from 2 to 16 μm. PMMA plates yield reasonable SPF estimates under a limited range of conditions. Ferrero et al. have evaluated the performance of substrates with various roughness values. See Ferrero et al., IFSCC Magazine 9(2): 97-108 (2006). Miura has reported results of a ring test comparing SPF results for substrates with 6 μm and 16 μm roughness values. The latter substrate was claimed to have a roughness value similar to that of skin and to permit application of 2 mg/cm² of sunscreen. See Miura, Comparison of high and low roughness substrates. Presentation to ISO TC217 WG7, Baltimore, Jun. 22, 2009. However, the 16 μm roughness substrate has shown results similar to those of the HD-6 plate, with no significant advantage in accuracy.

International Patent Application Publication No. WO 2008/113109 describes an artificial substrate made of two layers of polypropylene tape and a weighted mesh is forced onto the tape surface to emboss texture on the tape. The textured tape is then used as a SPF substrate. The foregoing substrate does not replicate the thickness distribution of skin and has not yielded an advantage over other currently available substrates.

U.S. Patent Application Publication No. 2010/0075360 A1 describes the use of mouse fibroblast cells and human keratinocytes for measuring SPF values. The cells are irradiated with UV dosages and then quantitating cell death by viable staining. This method requires expensive and time-consuming preparation of cell monolayers and may suffer from reproducibility problems.

A useful substrate should not only provide the film thickness distribution of sunscreens on skin, but also be transparent to UV, chemically and physically stable, resistant to solvents, non-fluorescing, and inexpensive.

The COLIPA Guidelines and the ongoing development of ISO standards have propagated an internationally accepted approach to in vitro measurements of sunscreen performance. See In vitro UV Protection Method Task Force, In vitro method for the determination of the UVA protection factor and critical wavelength values of sunscreen products, COLIPA (2011), which are hereby incorporated by reference for the teachings of the standard in vitro sunscreen performance measurements. These methods are applied not only to measurement of UVA protection factors and spectral ratio indexes of UVA protection for products with known SPF values, but also in efforts to measure SPF. Two PMMA substrates that have emerged in current guidelines and ongoing standard development: the Schönberg sandblasted 2 μm roughness plate (Schönberg Gmbh & Co KG, Hamburg, Germany) and the Helioscreen HD-6 molded plate with a 6 μm roughness (Helioscreen, Creil, France). The Helioscreen substrate is considered more representative of human skin. However, for a variety of reasons, in vitro SPF measurement of a representative sample of marketed sunscreen products has not been accomplished with consistently acceptable accuracy.

Sunscreen samples are applied to substrates as prescribed in the International SPF Method: multiple droplets are deposited with a syringe/pipette, then spread over the plate using a finger with light pressure with a duration of 20 to 50 seconds. See e.g., In vitro UV Protection Method Task Force, In vitro method for the determination of the UVA protection factor and critical wavelength values of sunscreen products, COPILA, 2011, which is hereby incorporated by reference for the standards for in vitro SPF measurements. The sunscreen is applied at 1.3 mg/cm², then rubbed for approximately one minute using a bare finger, and incubated at 35° C. for 30 minutes before undergoing measurements of UVR transmission. To account for a potential lack of photostability, plate transmission is measured again after a specified UV dose, which was selected empirically based on analysis of the results of a multi-laboratory study.

The currently recommended application amount of sunscreen on HD-6 plates is only 1.3 mg/cm² demonstrating that this goal has not been met. Moreover, the measured roughness value of the HD-6 plate is 6 μm, while that of human skin is reported to be approximately 17 μm. Thus, the Helioscreen HD-6 substrates do not accurately replicate the topography of skin or sunscreen application on human skin. For example, when 2 mg/cm² of a sunscreen is applied to the skin, a significant amount of the sunscreen accumulates in the sulci (valleys) of the skin, leaving the plateaus and peaks protected by a much thinner layer. O'Neill, J. Pharmaceut. Sci. 73:888-891 (1984). In order to replicate the actual thickness distribution of a sunscreen film applied to the skin at 2 mg/cm², the substrate must accommodate that amount of sunscreen and the relative thickness distributions seen on skin.

Further, substrates for measuring SPF have been designed to reproduce the topography of skin, by sandblasting or by molding. The actual simulation of skin topography has been poor, and researchers have attempted to compensate using elaborate schemes in the product application procedure, such as rubbing for various lengths of time at various pressures. These measures have improved accuracy for particular formulas, but optimum application techniques often differ for different formulas.

Historically, researchers have assumed that a substrate for in vitro measurements of sun protection should resemble skin, and its topography should model the film thickness distribution on skin, with application of 2 mg/cm² of sunscreen, as used for the in vivo SPF measurement that serves as a benchmark. However, as described herein, it is shown that substrates must provide the correct thickness distributions of a given sunscreen film, rather than mimicking skin surface topography. This facilitates the design of sunscreen substrates for optimal and reproducible application, which is difficult for substrates that mimic skin surface topography.

Substrates that approximate the distribution of sunscreen applied to human skin for SPF determination have been discussed in International Patent Application Publication No. WO 2012/125292, which is incorporated by reference herein for such teachings.

### SUMMARY

Described herein are processes, apparati, and substrates for acquiring images of sunscreen films on human skin for in vitro determination of sunscreen protection factors (SPF) incorporating image analyses.

Described herein is a substrate for determining the absorbance or transmission of a substance comprising an optically transparent material comprising a defined height and comprising one or more indentations comprising continuously or iteratively increasing depths, wherein the absorbance or transmission of a substance can be measured for a distribution of thicknesses simultaneously and image data obtained.

In one aspect of the substrate described herein, the substance is sunscreen.

In another aspect of the substrate described herein, the sunscreen substance comprises visible (colored), UV absorptive, UV reflective, fluorescent, phosphorescent, or reflective media.

In another aspect described herein, the optically transparent material is quartz, optically clear glass, polymethylmethacrylate, polystyrene, silica, sapphire, crystal, ceramic, or a biological film or membrane.

In another aspect of the substrate described herein, the indentations are rectangles, squares, trapezoids, polygons, ovals, or circles.

In another aspect of the substrate described herein, the defined height is from about 0.1 mm to about 10 mm.

In another aspect of the substrate described herein, the continuously or iteratively increasing depths are from about 0.01 mm to 9.5 mm.

In another aspect of the substrate described herein, the continuously or iteratively increasing depths are from about 0.001 mm to 0.01 mm.

Also described herein is a method for determining a film thickness distribution of a substance on a substrate, the method comprising: (a) applying a substance to a substrate, creating a film, the substrate comprising an optically transparent material comprising a defined height and comprising one or more indentation comprising continuously increasing depths wherein the transmission of a substance can be measured for a continuous distribution of thicknesses simultaneously; (b) applying a continuous or intermittent radiation source to the substance and substrate; (c) obtaining a digital image of the substance and any transmissions, absorbance, or emissions therefrom; and (d) performing image analysis of the digital image to determine a film thickness distribution for the substance.

One aspect of the method described herein utilizes the substrates described herein.

In another aspect of the method described herein, the substance is sunscreen.

In another aspect of the method described herein, the substance comprises a colored, UV absorptive, UV reflective, florescent, or luminescent dye.

Also described herein is a method for determining a film thickness distribution of sunscreen, the method comprising: (a) applying sunscreen to human or animal skin, wherein the sunscreen comprises a colored, UV absorptive, UV reflective, florescent, or luminescent dye; (b) applying a continuous or intermittent radiation source to the skin and sunscreen; (c) obtaining a digital image of the sunscreen, skin, and acquiring any transmissions, absorbances, or emissions therefrom; and (d) performing image analysis of the digital image and analysis of the transmission, absorbance or emission data to determine a film thickness distribution of the sunscreen.

Also described herein is a method for determining a film thickness distribution of sunscreen, the method comprising: (a) applying sunscreen to human, animal skin or artificial skin; (b) applying a continuous or intermittent radiation source to the skin and sunscreen; (c) obtaining a digital image of the sunscreen, skin, and acquiring any transmissions, absorbances, or emissions therefrom; and (d) performing image analysis of the digital image and analysis of the transmission, absorbance or emission data to determine a film thickness distribution of the sunscreen.

In one aspect of the method described herein, the sunscreen comprises visible (colored), UV absorptive, UV reflective, fluorescent, phosphorescent, or reflective media

In another aspect of the method described herein, the sun protection factor of the sunscreen is unknown.

Also described herein is the use of the methods described herein to develop substrates for determining sunscreen protection factors.

Also described herein is a method for developing a sunscreen substrate replicating the film thickness distribution of sunscreen on skin, the method comprising: (a) applying sunscreen to human, animal, or artificial skin; (b) applying a continuous or intermittent radiation source to the skin and sunscreen; (c) obtaining a digital image of the sunscreen, skin, and acquiring any transmissions, absorbances, or emissions therefrom; (d) performing image analysis of the digital image and analysis of the transmission, absorbance, or emission data to determine a film thickness distribution of the sunscreen; and (e) creating a sunscreen substrate that replicates the film thickness distribution on the skin.

Also described herein is the use of the methods described herein to develop substrates for determining sunscreen protection factors.

Also described herein are sunscreen substrates produced by the methods described herein.

Also described herein is the use of the substrates for determining the sun protection factor of a sunscreen.

In one aspect described herein, the sunscreen SPF is unknown.

Also described herein is a substrate for determining the SPF of a sunscreen comprising an optically transparent material comprising a defined height and comprising one or more indentations comprising continuously or iteratively increasing depths, wherein the sunscreen film thickness distribution on the substrate replicates the film thickness distribution of sunscreen on skin.

In one aspect described herein, the substrate comprising the optically transparent material is quartz, optically clear glass, polymethylmethacrylate, polystyrene, silica, sapphire, crystal, ceramics, or a biological film or membrane.

In another aspect described herein, the substrate indentation is a rectangle, square, trapezoid, polygon, oval, or circle.

In another aspect described herein, the substrate defined height is from about 0.1 mm to about 10 mm.

In another aspect described herein, the substrate continuously or iteratively increasing depths are from about 0.01 mm to 9.5 mm.

In another aspect described herein, the substrate continuously or iteratively increasing depths are from about 0.001 mm to 0.01 mm.

Also described herein is a virtual substrate comprised of a dynamic mathematical model of a derived set of film thicknesses with extinction profiles and photodegradation kinetics based on the concentrations and properties of test product ingredients.

Also described herein is a means for determining the film thickness distribution of a sunscreen on skin comprising: (a) a digital camera; (b) a UV or visible radiation source; and (c) optionally, a CCD, spectroradiometer, fluorometer, UV spectrometer, photodiode array, or integrating sphere; whereby (i) sunscreen is applied to the skin; (ii) continuous or intermittent radiation is applied to the skin and sunscreen; (iii) a digital image is acquired of the sunscreen and skin; (iv) optionally, any transmissions, absorbances, or emissions from the sunscreen and skin are acquired; (v) image analysis of the digital image is performed; (vi) optionally, analyses of the transmission, absorbance, or emission data are performed; and (vii) a film thickness distribution of the sunscreen on the skin is determined.

Also described herein are apparati for the determination of a sunscreen film thickness distribution on the skin incorporating image analyses as substantially described herein with reference to and as illustrated by the accompanying text and drawings.

Also described herein are apparati for the in vitro determination of sunscreen protection factors (SPF) incorporating image analyses as substantially described herein with reference to and as illustrated by the accompanying text and drawings.

Also described herein are methods for the determination of a sunscreen film thickness distribution on the skin incorporating image analyses as substantially described herein with reference to and as illustrated by the accompanying text and drawings.

Also described herein are methods for the in vitro determination of sunscreen protection factors (SPF) incorporating image analyses as substantially described herein with reference to and as illustrated by the accompanying text and drawings.

Also described herein are substrates for the in vitro determination of sunscreen protection factors (SPF) replicating the sunscreen film thickness distribution of sunscreen on skin as substantially described herein with reference to and as illustrated by the accompanying text and drawings.

Also described herein are substrates for the in vitro determination of sunscreen protection factors (SPF) incorporating image analyses as substantially described herein with reference to and as illustrated by the accompanying text and drawings.

### BRIEF DESCRIPTION OF THE DRAWINGS

FIG. 1. Photograph of untreated human skin. The photograph shows sulci (valleys), plateaus, peaks, and the deeper indentations of hair follicles.

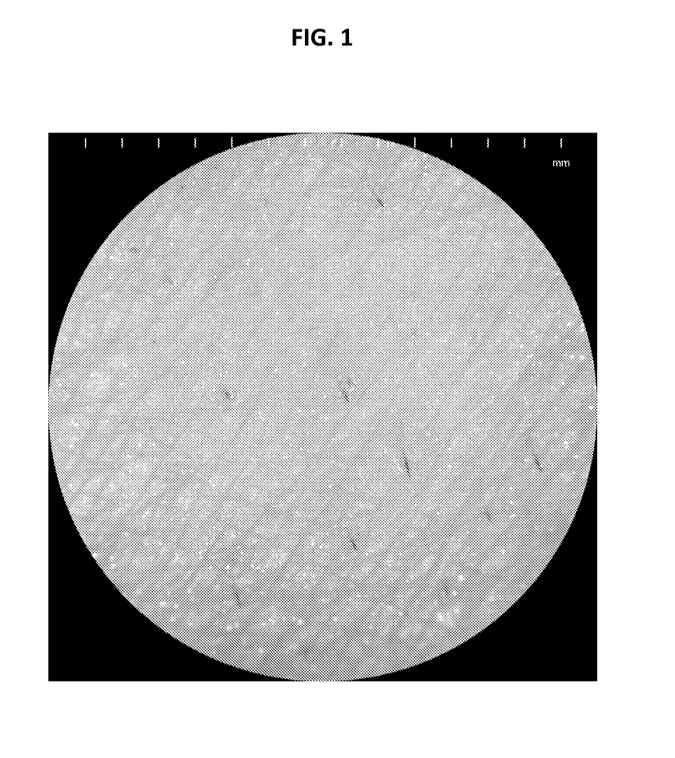

FIG. 2. Schematic cross-section of a sunscreen film on skin. Different types of sunscreen formulas produce different film thickness distributions and different degrees of penetration into the sulci and other indentations of skin. These indentations act as a reservoir and reduce the coverage of the peaks and plateaus. This diagram illustrates the need for establishing a unique film thickness distribution for each type of sunscreen formula.

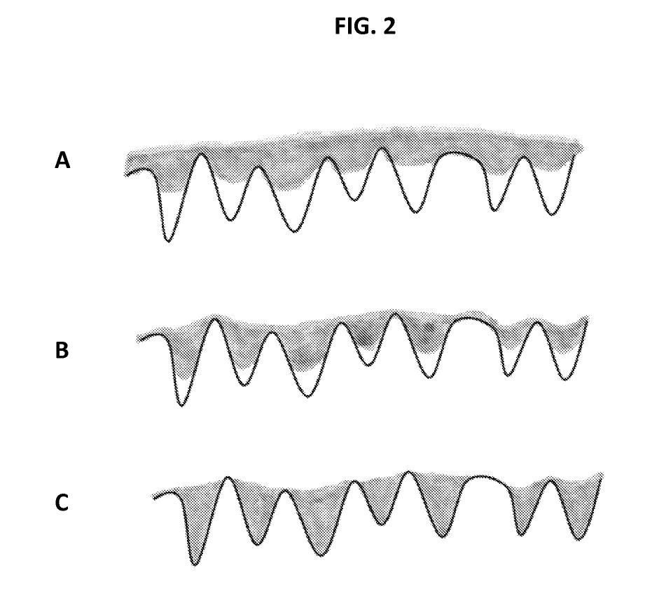

FIG. 3. Photograph of skin treated with a sunscreen containing a dye or fluorescent marker. The sunscreen covers the skin surface and fills the indentations in the skin to a certain degree. The film thickness is indicated by the darkness of the color, and thus maps the film thickness distribution. The distribution of pixels representing the photograph of the sunscreen film is expressed as a histogram, as shown in FIG. 5, which is an example of a histogram of the percentage of pixels at each of 256 brightness levels for an arbitrary plane (R, B, G or L), in this case, B.

FIG. 4. Graph of line profile of skin treated with a sunscreen containing a dye or fluorescent marker. The graph of color intensity or luminosity along an arbitrarily chosen line across the photograph of skin treated with sunscreen/dye provides a two dimensional profile of the film, which enables a preliminary estimate of the range of thicknesses present.

FIG. 5. Histogram of a photograph of skin treated with a sunscreen containing dye or fluorescent marker. The histogram yields the number of pixels for each of 256 levels of brightness within a selected area of interest in the photograph. In this example, assuming that the thickness distribution values correspond directly to the pixel histogram, except for a shift of approximately 60 intensity units to the left, the percentage of area represented by each film thickness value is represented in FIG. 6.

FIG. 6. Graph of correction factors for translating color or luminosity values into thickness values. The functional relationship between color or luminosity values and thickness values will be determined by measuring the color brightness or luminosity values corresponding to known thickness values of sunscreens impregnated with colored dye or fluorescent markers. This will permit translation of distributions of brightness or luminosity values into film thickness distributions. In the case of colored dyes, the color brightness or luminosity intensity will have an inverse relationship with film thickness, because the color brightness or luminosity is inversely proportional to film thickness and the line profile or histogram values increase with color brightness or luminosity.

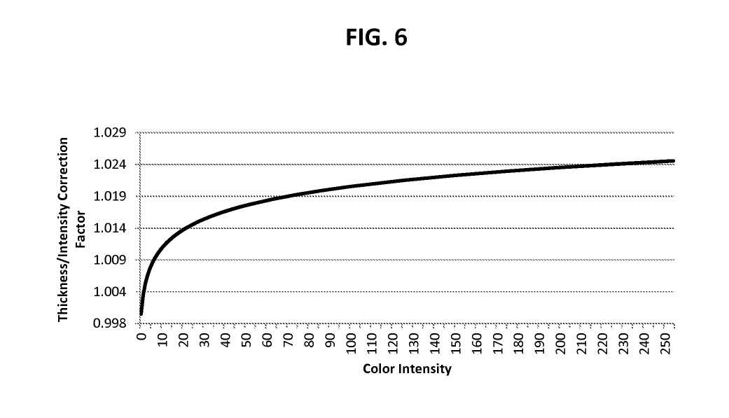

FIG. 7. Histogram of film thickness values. The histogram of film thickness values will yield the area fraction for each of 256 levels of film thickness, and thus the optimum film thickness distribution computed from the color brightness or luminosity of FIG. 5. The thickness histogram can be transformed into a substrate design with an indention containing the optimum thickness profile corresponding to the thickness distribution of the film thickness histogram, as shown in FIG. 8.

FIG. 8. Examples of substrates that embody computed area ratios. The two substrate examples illustrate possible configurations that satisfy the computed film thickness distributions resulting from the area ratios of FIG. 7. Only the relevant areas are used. Areas for thickness values approaching zero and thickness values that are essentially opaque to UVR are discarded. The lower substrate has vertical walls, which will facilitate precise leveling of the upper surface using a blade. This improves the reproducibility of sunscreen application. Note that there is no reason for the substrate indentation to resemble the thickness histogram, as long as the distribution of film thicknesses contains the required thickness values in the correct ratio. In fact, it is possible to design the substrate for optimum spreading accuracy and repeatability, as shown above. The sharp drops at the edges permit spreading with a blade or another substrate to obtain a precisely flat top film surface.

FIG. 9. Method for determining the sun protection factor (SPF) of sunscreen formulas. The process of measuring the applied effective UVR dose and the resulting transmitted effective UV dose yields the SPF. The SPF is the cumulative applied effective UVR dose that results in transmission of one MED (Minimal Erythema Dose).

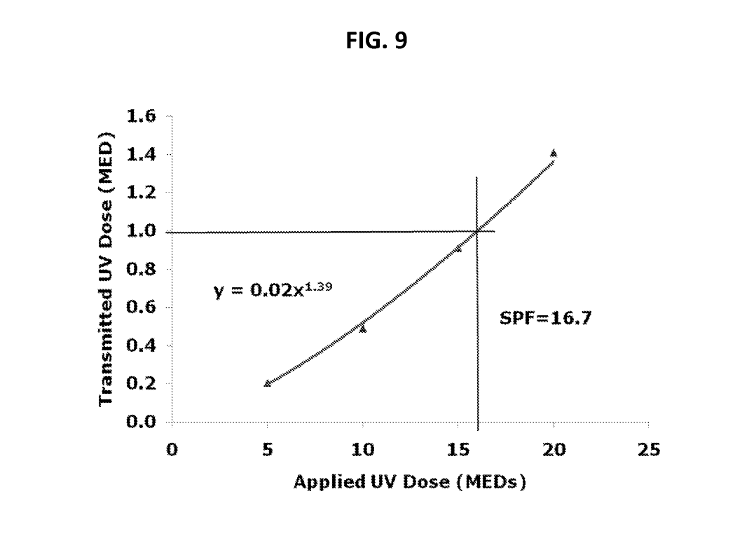

FIG. 10. Acquisition of an image of a sunscreen film on skin is accomplished by impregnating a sunscreen formula with a colored dye and photographing the reflected light with or without color and/or polarizing filters. In this case, the brightness of certain pixels will be directly or inversely proportional to the thickness of the sunscreen film.

FIG. 11. Acquisition of an image of a sunscreen film on skin is accomplished by impregnating a sunscreen formula with a material that emits fluorescence or phosphorescence energy in the visible or UV region when excited (illuminated) by certain wavelengths of visible light or UVR. An image of the fluorescent or phosphorescence emission is obtained selectively using a barrier filter that passes the fluorescent or phosphorescence emission wavelengths, but rejects the excitation wavelengths. In this case, the brightness of certain pixels will be directly proportional to the thickness of the sunscreen film.

FIG. 12. Acquisition of an image of a sunscreen film on skin is accomplished using the intrinsic skin fluorescence, attenuated by the sunscreen, either by virtue of the UV radiation absorbance properties of the sunscreen or by added colored dyes. In this case, the brightness of certain pixels will be inversely proportional to the thickness of the sunscreen film.

### DETAILED DESCRIPTION

Described herein are processes, apparati, and substrates for acquiring images of sunscreen films on human skin for in vitro determination of sunscreen protection factors (SPF) that incorporates image analyses.

As used herein, “brightness” refers to the quantity used herein in image analysis. “Color planes” refer to the red brightness, blue brightness, green brightness, and luminance refers to gray scale brightness. As used herein, the “luminance” refers to the extracted luminance plane from a color image. This is done by converting the color image to grayscale and then extracting one of the channels. As used herein, “darkness” refers to the inverse of brightness. Absorbers reduce brightness and diminish excitation. Accordingly, brightness is inversely proportional to thickness. As used herein, “emission” refers to increased brightness, which is proportional to excitation. Further, brightness is directly proportional to thickness. As used herein, “luminosity” is a measurement of brightness. “Luminance” refers to the photometric measure of the luminous intensity per unit area of light travelling in a given direction. As used herein, “luminescence” refers to the emission of light by a substance not resulting from heat.

Described herein are processes for in vitro determination of sunscreen protection factors (SPF) incorporating image analyses. The processes involve applying sunscreen films to human skin, illuminating the sunscreen/skin and recording the image using digital photography, analyzing the images, translating the distribution of optical features into histograms of film thickness distributions on the skin, and designing substrates that provide film thickness distributions that mimic those of sunscreens on skin. Sunscreen products are applied to substrates and spectroscopic measurements are performed to yield transmission spectra that permit computation of the sun protection factor (SPF) and additional parameters that describe the degree of protection against the damaging effects of sunlight.

In addition, the processes described herein entail obtaining digital images and using image analyses for determining distributions of pixel brightness values in the red (R), blue (B), green (G), and luminance (L) planes that reveal relative thickness distributions of sunscreen films applied to human skin. The derived in vivo thickness distribution is used for optimizing design of substrates for in vitro spectroscopic measurements of sunscreen transmission spectra. See Stanfield, In vitro techniques in sunscreen development. In: Shaath, Sunscreens: Regulations and Commercial Development (2005).

The image analyses described herein involve determination of the film thickness distribution of a sunscreen with or without impregnation with a colored, fluorescent, or phosphorescent dye that is photographed under ultraviolet radiation or visible light illumination.

Also described herein are substrates for measuring sunscreen SPF, wherein the sunscreen film thickness distribution on the substrate replicates the film thickness distribution of sunscreen on skin.

Described herein is a virtual substrate comprised of a dynamic mathematical model of a derived set of film thicknesses with extinction profiles and photodegradation kinetics based on the concentrations and properties of test product ingredients. See Herzog et al., J. Cosmet. Sci., 53: 11-26 (2002), which is incorporated by reference herein for such teachings.

Also described herein is the use of image analyses in designing substrates and developing methods for in vitro sunscreen protection determinations. Image analysis is the process of obtaining useful information from digital images. The information may include relative and absolute values of pixel brightness and spatial distributions thereof. Capabilities of computerized image analysis include classifying regions by brightness levels in red, blue, green and luminosity planes, assigning pseudocolors to regions with defined brightness levels, and line profiles and histograms that selectively display distributions of pixels with specific colors and luminosity values. See Klimek & Wright, Manual for Spotlight-16, an open source, image analysis software package, NASA Glenn Research Center, Cleveland, Ohio.

The transmission spectrum of a sunscreen formula on skin is the basic in vitro spectroscopic measurement that enables computations of the sun protection factor (SPF), absorbance spectra at various time intervals, the integrated absorbance spectrum, the critical wavelength, the UVA protection factor (UVAPF) and the ratio of the UVAPF to the SPF, before and during irradiation with ultraviolet energy (UVR). See COLIPA, In vitro UV Protection Method Task Force, In vitro method for the determination of the UVA protection factor and critical wavelength values of sunscreen products (2009); Stanfield, Osterwalder, & Herzog, Photochem. Photobiol. Sci. 9: 489-494 (2010).

Applications described herein include:
1. Use of the distribution of picture elements (pixels) in a digital image as a surrogate for the thickness distribution of a sunscreen film that influences its ability to protect skin from the effects of ultraviolet radiation.
2. The design of substrates that provide the specific thickness distribution of a given sunscreen film, rather than mimicking skin surface topography.
3. The development of apparati useful for conducting measurements as described herein and analyzing the data.

Also described herein are apparati and substrates for the in vitro determination of sunscreen protection factors (SPF) incorporating image analyses as substantially described herein with reference to and as illustrated by the accompanying text and drawings.

### EXAMPLES

### Example 1

There are numerous types of sunscreen formulas, e.g., oil-in-water emulsions, water-in oil emulsions, creams, gels, oils, lip balms, sprays, formulas containing organic UVR absorbing ingredients and formulas containing inorganic UVR absorbing and scattering ingredients, such as titanium dioxide and zinc oxide. Different types of formulas produce differing thickness distributions and differing degrees of penetration into the sulci and other indentations of skin. These indentations act as a reservoir and diminish the thickness of coverage of the peaks and plateaus on the skin surface, when a given amount of sunscreen is applied to the skin. The regions of thin coverage of the skin have a disproportionally strong effect on the sunscreen transmission spectrum. See O'Neill, J. Pharmaceut. Sci. 73:888-891 (1984).

The ability to characterize the specific film thickness distribution for a particular sunscreen formula or type of sunscreen formula on human or animal skin permits the acquisition of transmission spectra using substrates specific for particular types of sunscreen formulas.

### Image Acquisition

Sunscreens are applied to the skin of human volunteers according to current procedures for testing sunscreen products and digital photographic images of sunscreen films will be obtained. See Labeling and Effectiveness Testing; Sunscreen Drug Products for Over-the-Counter Human Use, U.S. Food and Drug Administration, 21 CFR Parts 201 and 310, Federal Register, Vol. 76, No. 117, Friday, Jun. 17, 2011, pp. 35620-35665.

Several different approaches are used to determine the optimum method(s) for acquiring typical film thickness distributions for a broad variety of sunscreen formulas. Three approaches are described.

### Method 1

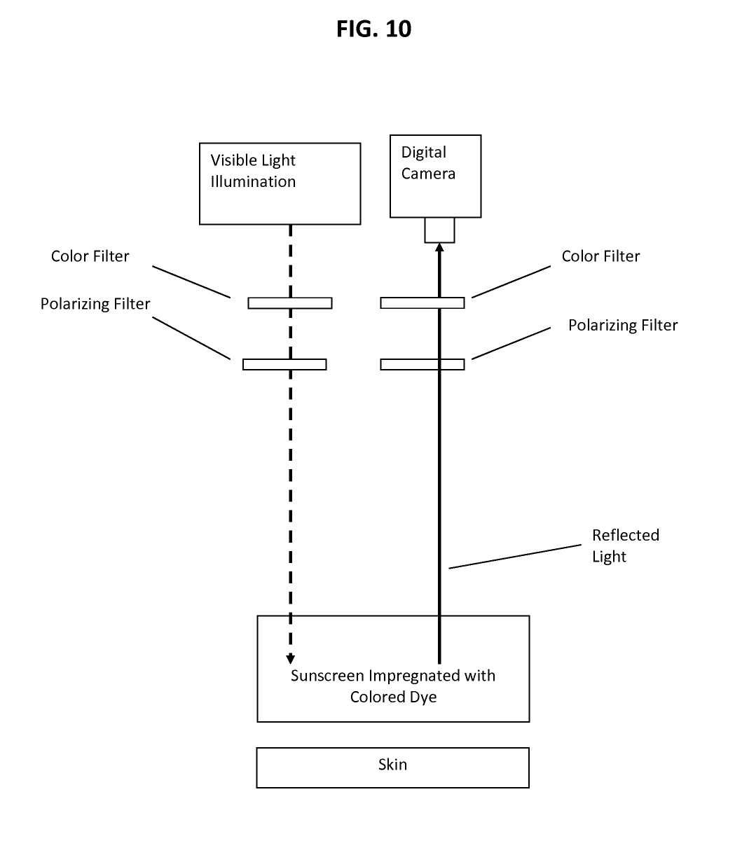

Acquisition of an image of a sunscreen film on skin is accomplished by impregnating a sunscreen formula with a colored, UV absorptive, UV reflective, fluorescent, or phosphorescent dye and photographing the reflected light with or without color and/or polarizing filters. In this case, the brightness of certain pixels is directly or inversely proportional to the thickness of the sunscreen film. See the schematic diagram in FIG. 10.

### Method 2

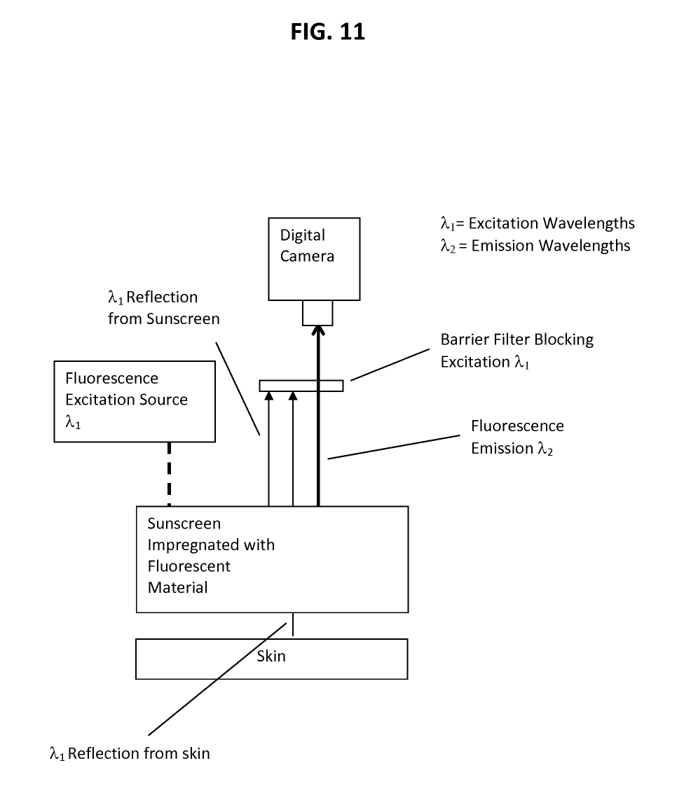

Acquisition of an image of a sunscreen film on skin is accomplished by impregnating a sunscreen formula with a material that emits fluorescence or phosphorescence energy in the visible or UV region when excited (illuminated) by certain wavelengths of visible light or UV radiation. An image of the fluorescent or phosphorescence emission is obtained selectively using filter(s) that passes the emission wavelengths, but rejects the excitation wavelengths. In this case, the brightness of certain pixels is directly proportional to the thickness of the sunscreen film. See the schematic diagram in FIG. 11.

### Method 3

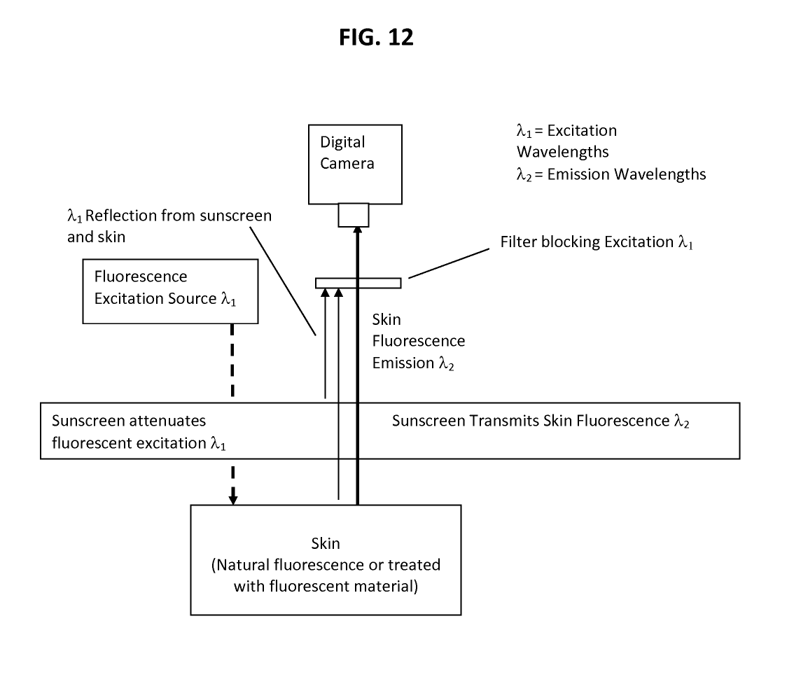

Acquisition of an image of a sunscreen film on skin is accomplished using the intrinsic skin fluorescence or phosphorescence, attenuated by the sunscreen, either by virtue of its UV radiation absorbance properties or by added colored, UV absorptive, UV reflective, fluorescent, or phosphorescent dyes. In this case, the brightness of certain pixels is directly or inversely proportional to the thickness of the sunscreen film. See the schematic diagram in FIG. 12.

The UVR or visible light excitation source can be a filtered xenon flash lamp, continuous xenon arc lamp, incandescent lamp, white light, UVR fluorescent lamp, metal halide lamp, laser, or other types of viable, UV, and/or infrared sources. The source spectra will be chosen to provide selective imagery of the sunscreen film, based on the sensitivity of the digital camera and the geometry of the photographic set-up.

Images are obtained using linear, circular polarization, cross polarization, or confocal illumination.

The digital camera can be a digital visible light camera, UV camera, or a charge coupled device (CCD). The camera can be used alone or coupled with a CCD, spectroradiometer, fluorometer, UV spectrometer, photodiode array, integrating sphere, photomultiplier tube, inter alia, to simultaneously obtain image and spectrometry/fluorescence data.

Fluorescent emission materials for impregnating the sunscreens and/or treating the skin may include but are not limited to: curcumin, sodium fluorescein, rhodamine, indocyanine green, hemoglobin, melanin, nucleic acids, NAD/NADH, urocanic acid, porphyrins, tryptophan, collagen, elastin, keratin, dansyl chloride, dihydroxyacetone, green fluorescent proteins, luciferase, chemiluminescent substrates, and other biologically compatible fluorophores. See Stokes & Diffey, J. Photochem. Photobiol. Biol. 50:137-143 (1999); Sandby-Moller et al., Photodermatol. Photoimmunol. Photomed. 20: 33-40 (2004); Kollias et al. Vibrational Spectrosc. 28: 17-23 (2002); Ruvolo, et al., Photodermatol. Photoimmunol. Photomed. 25: 298-304 (2009); Kumar et al., Applied Phys. Lett., 100: 203701-203702 (2012); Liang et al., J. Biomed Opt. 17: 070501 (Jun. 28, 2012).

### Image Analysis

The images obtained from sunscreen films consists of pixels with 2 dimensional spatial distributions and discrete brightness values from 0 to 255 of brightness in the R, G, B and luminance planes (8-bit imaging system). Brightness values may be over 16 million for greater pixel depths.

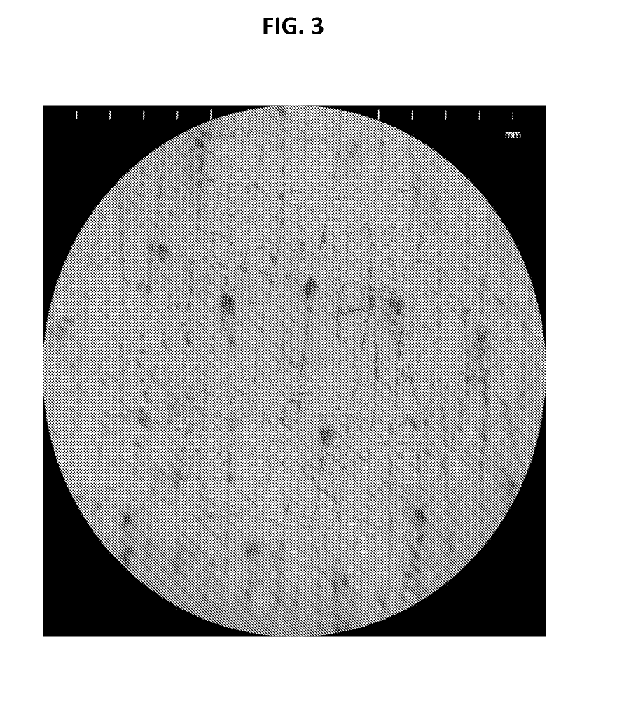

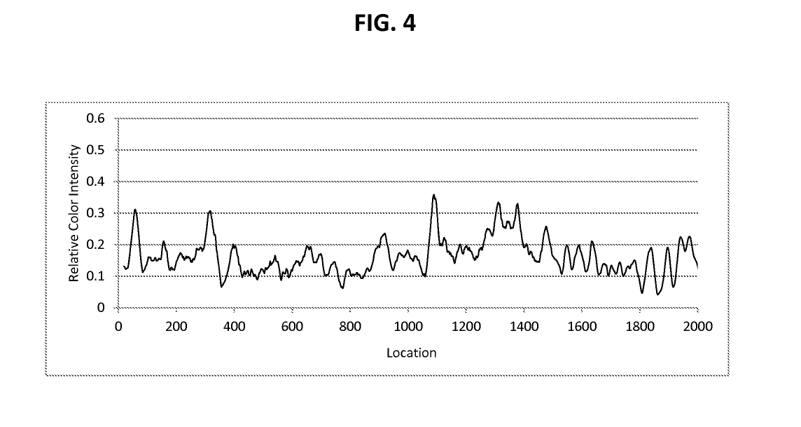

An example of an image of a sunscreen film containing a blue dye on human skin is shown in the blue plane in FIG. 3. The skin sulci (furrows) and hair follicles serve as reservoirs for sunscreen accumulation and the plateaus and peaks have sparser coverage by the sunscreen film. A graph of color intensity or luminosity along an arbitrarily chosen line across the photograph of skin treated with sunscreen/dye provides a two dimensional profile of the film, which enables a preliminary estimate of the range of thicknesses present (FIG. 4).

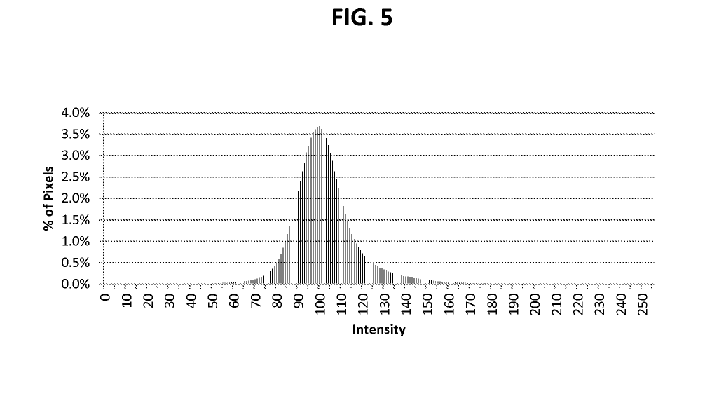

The distribution of pixels representing the photograph of the sunscreen film is expressed as a histogram, as shown in FIG. 5, which is an example of a histogram of the percentage of pixels at each of 256 levels of color or luminosity intensities for an arbitrary plane (Red, Blue, Green, or Luminosity), in this case, Blue.

The relationship between color or luminosity intensity values and thickness values is determined by measuring the color or luminosity values corresponding to known thickness values of sunscreens impregnated with colored, UV absorptive, UV reflective, fluorescent, or luminescent dyes or markers. Standards of known thicknesses of the sunscreen can be used to construct standard curves of the measured values (e.g., transmission, absorption, fluorescence, or phosphorescence). This permits translation of distributions of color, transmission, absorption, fluorescence, or luminosity values into film thickness distributions. In the case of colored dyes, the color brightness or luminosity will have an inverse relationship with film thickness, since the absorbance of colors light is proportional to film thickness and the line profile or histogram values increase with color brightness or luminosity. In other examples, such as fluorescence, or phosphorescence emission is proportional to the film thickness, accounting for absorption by the sunscreen and/or its additives.

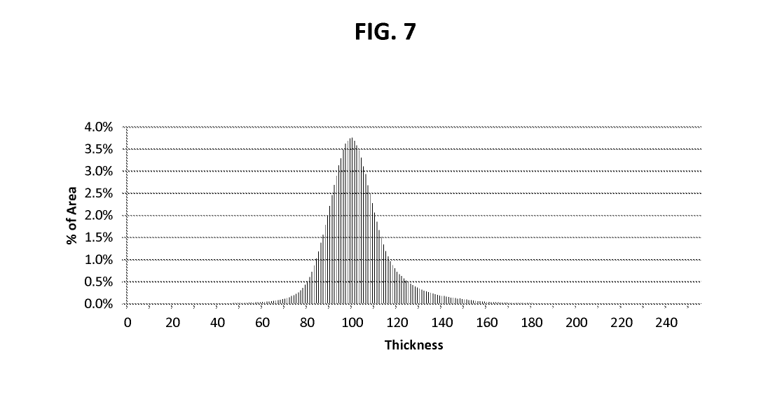

In the examples described herein, assuming that the thickness distribution values correspond directly to the pixel histogram, the percentage of area represented by each film thickness value is represented in FIG. 7. Finally, the thickness histogram is transformed into a substrate design with an indention containing the optimum thickness profile corresponding to the thickness distribution of the film thickness histogram, as shown in FIG. 7.

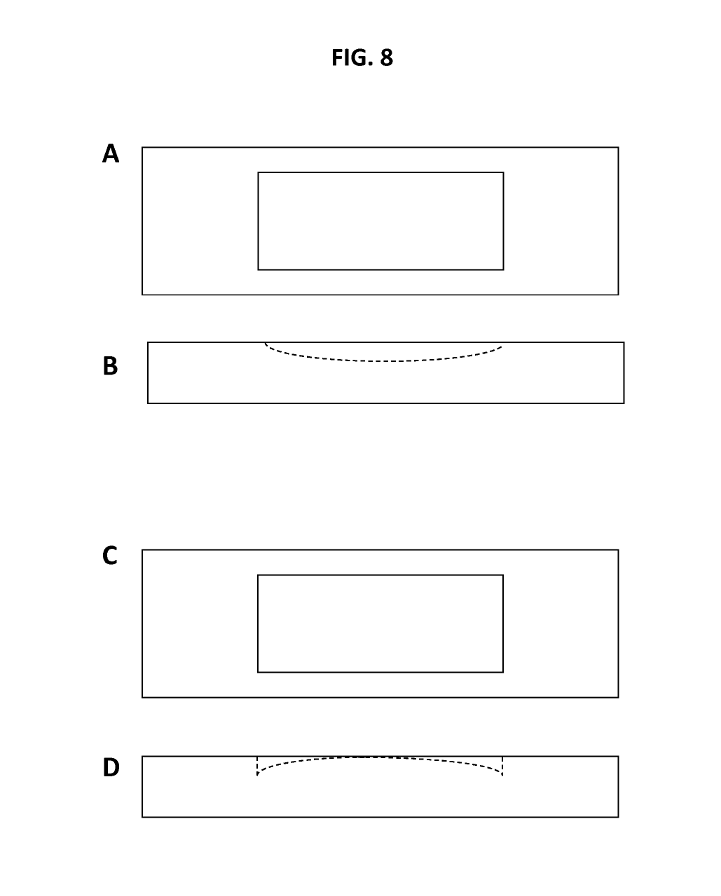

The substrate examples shown in FIG. 8 illustrate two exemplary configurations that satisfy the calculated film thickness distributions resulting from the area ratios of FIG. 7. Only the relevant areas are used. Areas for thickness values approaching zero and thickness values that are essentially opaque to UV/Vis radiation are discarded. The bottom substrate (FIGS. 8 C and D) has vertical walls, which will facilitate precise leveling of the upper surface using a blade or rubber spatula. This can improve the reproducibility of sunscreen application.

The substrate indentations need not resemble the thickness histogram, so long as the distribution of film thicknesses contains the required thickness values in the correct ratio. In fact, it is possible to design a substrate with proper distribution of film thickness that is optimized for sunscreen application spreading accuracy and reproducibility. The sharp, vertical (90°) drops at the edges permit spreading with a blade or another substrate to obtain a precisely flat film surface.

The process of measuring the applied effective UVR dose and the resulting transmitted effective UV dose yields the SPF. The SPF is the cumulative applied effective UV radiation dose that results in transmission of one MED (Minimal Erythema Dose). Methods for SPF determination are discussed in International Patent Application Publication No. WO 2012/125292, which is incorporated by reference herein for such teachings.

The scope of the apparati, devices, procedures, and methods described herein includes all disclosed and potential combinations of aspects, embodiments, examples, and preferences herein described.

1. A substrate for determining the absorbance or transmission of a substance comprising an optically transparent material comprising a defined height and comprising one or more indentations comprising continuously or iteratively increasing depths, wherein the absorbance or transmission of a substance can be measured for a distribution of thicknesses simultaneously and image data obtained.

2. The substrate of claim 1, wherein the substance is sunscreen.

3. The substrate of claim 2, wherein the sunscreen comprises visible (colored), UV absorptive, UV reflective, fluorescent, phosphorescent, or reflective media.

4. The substrate of claim 1, wherein the optically transparent material is quartz, optically clear glass, polymethylmethacrylate, polystyrene, silica, sapphire, crystal, ceramic, or a biological film or membrane.

5. The substrate of claim 1, wherein the indentations are rectangular, square, trapezoidal, polygonal, oval, or circular.

6. The substrate of claim 1, wherein the defined height is from about 0.1 mm to about 10 mm.

7. The substrate of claim 1, wherein the continuously or iteratively increasing depths are from about 0.01 mm to 9.5 mm.

8. The substrate of claim 1, wherein the continuously or iteratively increasing depths are from about 0.001 mm to 0.01 mm.

9. A method for determining a film thickness distribution of a substance on a substrate, the method comprising:
(a) applying a substance to a substrate, creating a film, the substrate comprising an optically transparent material comprising a defined height and comprising one or more indentations comprising continuously or iteratively increasing depths wherein the transmission of a substance can be measured for a continuous distribution of thicknesses simultaneously;
(b) applying a continuous or intermittent radiation source to the substance and substrate;
(c) obtaining a digital image of the substance and any transmissions, absorbance, or emissions therefrom; and
(d) performing image analysis of the digital image to determine a film thickness distribution for the substance.

10. The method of claim 9, utilizing the substrate of claim 1.

11. The method of claim 9, wherein the substance is sunscreen.

12. The method of claim 11, wherein the sunscreen comprises a colored, UV absorptive, UV reflective, florescent, or luminescent dye.

13. (canceled)

14. A method for determining a film thickness distribution of sunscreen, the method comprising:
(a) applying sunscreen to human skin, animal skin or artificial skin;
(b) applying a continuous or intermittent radiation source to the skin and sunscreen;
(c) obtaining a digital image of the sunscreen, skin, and acquiring any transmissions, absorbances, or emissions therefrom; and
(d) performing image analysis of the digital image and analysis of the transmission, absorbance or emission data to determine a film thickness distribution of the sunscreen.

15. The method of claim 14, wherein the sunscreen comprises visible (colored), UV absorptive, UV reflective, fluorescent, phosphorescent, or reflective media.

16. The method of claim 14, wherein the sun protection factor of the sunscreen is unknown.

17. (canceled)

18. A method for developing a sunscreen substrate replicating the film thickness distribution of sunscreen on skin, the method comprising:
(a) applying sunscreen to human, animal, or artificial skin;
(b) applying a continuous or intermittent radiation source to the skin and sunscreen;
(c) obtaining a digital image of the sunscreen, skin, and acquiring any transmissions, absorbances, or emissions therefrom;
(d) performing image analysis of the digital image and analysis of the transmission, absorbance, or emission data to determine a film thickness distribution of the sunscreen; and
(e) creating a sunscreen substrate that replicates the film thickness distribution on the skin.

19-29. (canceled)

30. An apparatus for determining the film thickness distribution of a sunscreen on skin comprising:
(a) one or more digital cameras and;
(b) a UV or visible radiation source; and
(c) optionally, a CCD, spectroradiometer, fluorometer, UV spectrometer, photodiode array, or integrating sphere;
whereby
(i) sunscreen is applied to the skin;
(ii) continuous or intermittent radiation is applied to the skin and sunscreen;
(iii) a digital image is acquired of the sunscreen and skin;
(iv) optionally, any transmissions, absorbances, or emissions from the sunscreen and skin are acquired;
(v) image analysis of the digital image is performed;
(vi) optionally, analyses of the transmission, absorbance, or emission data are performed; and
(vii) a film thickness distribution of the sunscreen on the skin is determined.

31-36. (canceled)

37. The substrate of claim 2 wherein the sunscreen film thickness distribution on the substrate replicates the film thickness distribution of sunscreen on skin.
